(19) United States
(12) Patent Application Publication
(10) Pub. No.: US 2018/0058369 A1
(43) Pub. Date: Mar. 1, 2018

(54) CYLINDER BLOCK FOR INTERNAL COMBUSTION ENGINE

(71) Applicant: TOYOTA JIDOSHA KABUSHIKI KAISHA, Toyota-shi (JP)

(72) Inventor: Takashi AMANO, Susono-shi (JP)

(73) Assignee: TOYOTA JIDOSHA KABUSHIKI KAISHA, Toyota-shi (JP)

(21) Appl. No.: 15/642,551

(22) Filed: Jul. 6, 2017

(30) Foreign Application Priority Data
Aug. 29, 2016 (JP) 2016-167110

(51) Int. Cl. F02F 1/10; F02F 1/24

(52) U.S. Cl. CPC F02F 1/10; F02F 7/0007; F02F 1/24

(57) ABSTRACT

A cylinder block is provided with a cylinder bore wall section configured to support a piston which reciprocates in a cylinder bore. The cylinder bore wall section includes a hollow portion at a location of the cylinder bore wall section on the side away from a cylinder head in the cylinder axial direction. The width of the hollow portion in the cylinder radial direction is greater on the side away from the cylinder head in the cylinder axial direction than the side closer to the cylinder head.

### CROSS-REFERENCE TO RELATED APPLICATION

This application is based on and claims the benefit of Japanese Patent Application No. 2016-467110, filed on Aug. 29, 2016, which is incorporated by reference herein in its entirety.

### BACKGROUND

### Technical Field

The present disclosure relates to a cylinder block for an internal combustion engine.

### Background Art

For example, JP 2015-229988 A disclose a cylinder block for an internal combustion engine. This cylinder block is provided with a cylinder bore wall section and a water jacket. The cylinder bore wall section is configured to support a piston which reciprocates in a cylinder bore. The water jacket is formed so as to surround the cylinder bore wall section. In the cylinder block disclosed in JP 2015-229988 A, a water jacket spacer is inserted into the water jacket in order to reduce the temperature difference in the cylinder bore wall section in the cylinder axial direction. To be more specific, the water jacket spacer is configured by a synthetic resin base plate, a spacer main body provided at a necessary location of this synthetic resin base plate and a spring.

In addition to JP 2015-229988 A, 2010-169049 A and JP 2010-190138 A are patent documents which may be related to the present disclosure.

### SUMMARY

If a water jacket spacer is provided as disclosed in JP 2015-229988 A in order to reduce the temperature difference in a cylinder bore wall section in the cylinder axial direction, there is a possibility that the number of parts of the internal combustion engine may increase. In addition, there is a possibility that, in order to incorporate the water jacket spacer into the cylinder block, a lot of work may be required.

The present disclosure has been made in the light of the problem as described above, and an object of the present disclosure is to provide a cylinder block for an internal combustion engine that can reduce the temperature difference in a cylinder bore wall section in the cylinder axial direction without an increase of the number of parts of the internal combustion engine.

A cylinder block for an internal combustion engine according to the present disclosure includes a cylinder bore wall section configured to support a piston which reciprocates in a cylinder bore. The cylinder bore wall section includes a hollow portion at a location of the cylinder bore wall section on a side away from the cylinder head in a cylinder axial direction. A width of the hollow portion in a cylinder radial direction is greater on the side away from the cylinder head in the cylinder axial direction than on a side closer to the cylinder head.

The hollow portion may be formed such that the width of the hollow portion in the cylinder radial direction becomes gradually greater as the hollow portion becomes farther away from the cylinder head in the cylinder axial direction.

The cylinder block may further include a water jacket formed so as to surround the cylinder bore wall section. In a view of the cylinder block from the cylinder axial direction, with respect to a cylinder circumferential direction, the hollow portion may be formed only at a location of the cylinder bore wall section on an inner side in the cylinder radial direction than the water jacket.

The supply of heat from combustion gas to the cylinder bore wall section is performed mainly with respect to the location of the cylinder bore wall section on the side closer to the cylinder head. Thus, with respect to the cylinder axial direction, there is a basic tendency that the longer the distance from the cylinder head is, the lower the temperature of the cylinder bore wall section becomes. According to the cylinder block for an internal combustion engine of the present disclosure, the cylinder bore wall section includes the hollow portion at the location of the cylinder bore wall section on the side away from the cylinder head in the cylinder axial direction. The hollow portion serves as a heat insulating layer, and hinders heat transfer in the cylinder bore wall section from the side of the cylinder bore toward the outer side in the cylinder radial direction. Therefore, with the cylinder block according to the present disclosure, the heat transfer (heat convection) from the side of the cylinder bore toward the cylinder bore wall section can be facilitated at the location of the cylinder bore wall section on the side where the hollow portion is not provided (that is, at the location thereof on the side closer to the cylinder head). In addition, with the cylinder block according to the present disclosure, at the location of the cylinder bore wall section on the side where the hollow portion is present (that is, at the location thereof on the side away from the cylinder head), the heat transfer toward the cylinder bore wall section can be reduced by the hollow portion. Furthermore, in the hollow portion of the cylinder block according to the present disclosure, the width of the hollow portion in the cylinder radial direction is greater on the side away from the cylinder head in the cylinder axial direction than on the side closer to the cylinder head. Therefore, with the hollow portion of the cylinder block according to the present disclosure, the heat insulating effect can be enhanced more effectively on the side away from the cylinder head than on the side closer to the cylinder head. Consequently, at the location of the cylinder bore wall section on the side where the hollow portion is present, the heat transfer toward the cylinder bore wall section can be reduced more effectively on the side away from the cylinder head than on the side closer to the cylinder head. From the above, with the cylinder block according to the present disclosure, the temperature difference in the cylinder bore wall section in the cylinder axial direction can be reduced effectively without an increase of the number of parts of the internal combustion engine.

### BRIEF DESCRIPTION OF THE DRAWINGS

FIG. 1 is a plan view of a cylinder block for an internal combustion engine according to a first embodiment of the present disclosure viewed from the side of a cylinder head in a cylinder axial direction;

FIG. 2 is a schematic diagram that shows a cross-sectional shape of the cylinder block taken along the line A-A in FIG. 1;

FIG. 3 is a diagram that shows a cross-sectional shape of the cylinder block taken along the line B-B in FIG. 2;

FIG. 4 is a schematic diagram for describing a configuration of hollow portions included in a cylinder block according to a second embodiment of the present disclosure; and

FIG. 5 is a schematic diagram for describing a configuration of hollow portions included in a cylinder block according to a third embodiment of the present disclosure.

### DETAILED DESCRIPTION

In the following, embodiments of the present disclosure will be described with reference to the drawings. The present disclosure is not limited to the embodiments described below, and various modifications can be made to the embodiments without departing from the scope of the present disclosure. In addition, throughout the drawings, the same or similar components are denoted by the same reference numerals.

### First Embodiment

### Overall Configuration of Cylinder Block

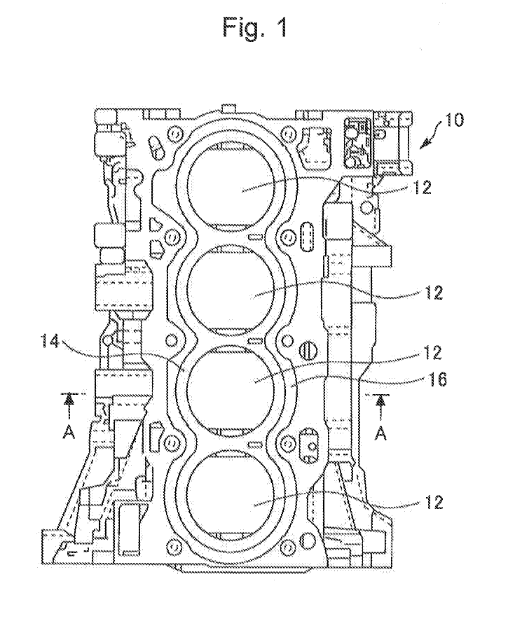

FIG. 1 is a plan view of a cylinder block 10 for an internal combustion engine according to the first embodiment of the present disclosure viewed from the side of a cylinder head 18 in the cylinder axial direction. The cylinder block 10 shown in FIG. 1 is for a four-cylinder in-line engine, for example, and includes four cylinder bores 12 arranged in a row.

The cylinder block 10 is provided with a cylinder bore wall section 14 that is a section that forms the cylinder bores 12. The cylinder bore wall section 14 supports pistons (not shown) which are inserted into the respective cylinder bores 12 such that the pistons can reciprocate in the respective cylinder bores 12. In addition, the cylinder block 10 is provided with a water jacket 16 that is formed so as to surround the cylinder bore wall section 14.

To be more specific, in the example shown in 1, the cylinder bore wall section 14 has a structure that wall parts thereof surrounding the respective four cylinder bores 12 are integrally connected with each other (a so-called Siamese structure). Moreover, in the view of the cylinder block 10 from the cylinder axial direction, the water jacket 16 is formed so as to surround, along the shape of the cylinder bore wall section 14, the entire outer circumference of the cylinder bore wall section 14 that is integrally connected as just described. Thus, in the example shown in FIG. 1, the water jacket 16 is thrilled so as to surround, not the entire outer circumference of each wall part in the cylinder circumferential direction, but a part of the entire outer circumference of each wall part.

### Configuration of Hollow Portion

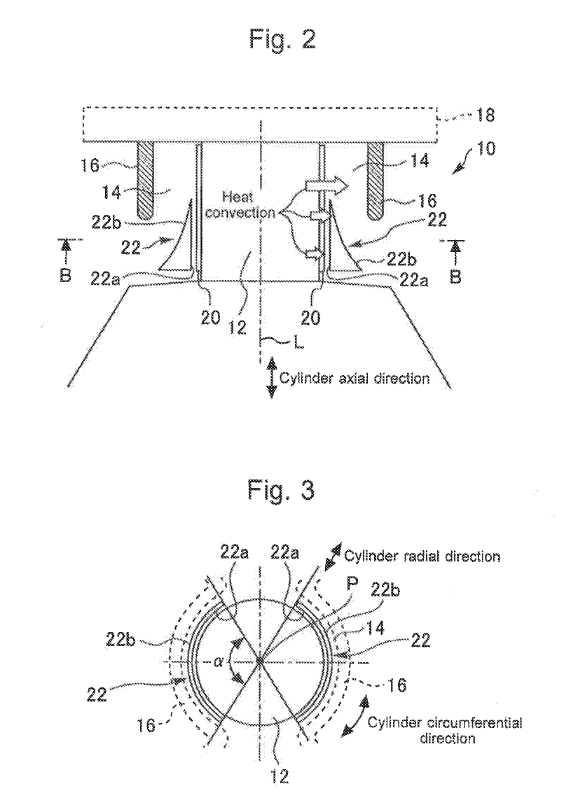

FIG. 2 is a schematic diagram that shows a cross-sectional shape of the cylinder block 10 taken along the line A-A in FIG. 1. In addition, the line A-A passes through the center of each of the cylinder bores 12 in the view of the cylinder block 10 from the cylinder axial direction. As shown in FIG. 2, the cylinder bore wall section 14 according to the present embodiment includes cylindrical cylinder liners 20 for forming the respective cylinder bores 12. Thus, the inner circumference surface of each of the cylinder liners 20 serves as the circumference surface of each of the cylinder bores 12. Each of the cylinder liners 20 is formed so as to correspond to the sliding range of the piston in the cylinder axial direction, and, in other words, is formed so as to substantially cover the whole of the cylinder bore 12. Moreover, in the example shown in FIG. 2, the water jacket 16 is formed so as to surround a part of the cylinder bore 12 in the cylinder axial direction (more specifically, a part of the cylinder bore 12 at a location closer to the cylinder head 18).

As shown in FIG. 2, the cylinder bore wall section 14 according to the present embodiment includes hollow portions 22 for the respective cylinder bores 12. Each of the hollow portions 22 is formed in the cylinder bore wall section 14 at a location on the side away from the cylinder head 18 in the cylinder axial direction. More specifically, in the example shown in FIG. 2, with respect to the cylinder axial direction, each of the hollow portions 22 is formed so as to extend from the vicinity of the end part of the water jacket 16 on the side away from the cylinder head 18 to the vicinity of the end part of the cylinder liner 20 on the side away from the cylinder head 18 (in other words, to the vicinity of the end on the side of the bottom dead center in the sliding range of the piston). With respect to the cylinder radial direction, each of the hollow portions 22 is formed so as to be located between the cylinder liner 20 and the water jacket 16, for example. In addition, in the cylinder radial direction, each of the hollow portions 22 is provided at a location closer to the circumference surface of the cylinder bore 12. Furthermore, as shown in FIG. 2, an inner circumference surfaces 22a of each hollow portion 22 facing the cylinder liner 20 is formed so as to be parallel to the cylinder axis line L, as an example.

Moreover, each of the hollow portions 22 is formed such that the width of the hollow portion 22 in the cylinder radial direction is greater on the side away from the cylinder head 18 in the cylinder axial direction than on the side closer to the cylinder head 18. More specifically, each of the hollow portions 22 is formed such that the width of the hollow portion 22 in the cylinder radial direction becomes gradually (in more detail, continuously) greater as the hollow portion 22 is farther away from the cylinder head 18 in the cylinder axial direction. In other words, each of the hollow portions 22 gradually (in more detail, continuously) enlarges in the cylinder radial direction as the hollow portion 22 is farther away from the cylinder head 18 in the cylinder axial direction. Also, in the example shown in FIG. 2, the width of each hollow portion 22 in the cylinder radial direction becomes greatest at the end thereof on the side away from the cylinder head 18 in the cylinder axial direction. In addition, an outer circumference surface 22b of each hollow portion 22 on the outer side in the cylinder radial direction is shaped with a curve (as an example, a curve that is convex to the inner side in the cylinder radial direction) in the cross-section of the cylinder block 10 that is perpendicular to the cylinder axis line L as shown in FIG. 2.

Furthermore, each of the hollow portions 22 according to the present embodiment is formed, for example, as a space having a constant width in the cylinder circumferential direction. Thus, it can be said that the area of the cross-sections of each hollow portion 22 that are perpendicular to the cylinder axis direction gradually increases as the hollow portion 22 is farther away from the cylinder head 18 in the cylinder axial direction.

FIG. 3 is a diagram that shows a cross-sectional shape of the cylinder block 10 taken along the line B-B in FIG. 2. In addition, the line B-B is perpendicular to the cylinder axis line L at a location at which the hollow portion 22 is present. In the present embodiment, the location of each hollow portion 22 with respect to the cylinder circumferential direction is further defined as follows with a positional relationship between the hollow portion 22 and the water jacket 16. More specifically, in the view of the cylinder block 10 from the cylinder axial direction as shown in FIG. 3, each of the hollow portions 22 is formed only at a location of the cylinder bore wall section 14 on the inner side in the cylinder radial direction than the water jacket 16. That is, each of the hollow portions 22 is not formed at a location between the cylinder bores 12 at which the water jacket 16 is not provided. In other words, in the view of the cylinder block 10 from the cylinder axial direction, each of the hollow portions 22 is formed so as to fall within a range of angle α around the center point P of the cylinder bore 12, that is, a range in which the water jacket 16 is present. Thus, each of the hollow portions 22 according to the present embodiment is provided in such a manner that the hollow portion 22 is divided into two sub-portions per cylinder bore 12.

Additionally, in the configuration of the cylinder block 10, with respect to two cylinder bores 12 located at the opposite ends, the water jacket 16 is present in such a manner as to exceed the range of angle α described above and to extend to the opposite ends in the row direction of the cylinder bores 12, in contrast to two cylinder bores 12 located on the center side. Accordingly, with respect to the two cylinder bores 12 located at the opposite ends, the hollow portions 22 thereof may be formed additionally in such a manner as to exceed the range of angle α. However, in the present embodiment, in order to reduce the difference in the in-cylinder temperature between cylinders, the formation of the hollow portions 22 in a manner shown in FIG. 3 is also applied to the two cylinder bores 12 located at the opposite ends.

### Method for Producing Cylinder Block with Hollow Portion

The cylinder block 10 in which the hollow portions 22 are formed can be produced by a three-dimensional molding machine, for example. The cylinder block 10 is formed by a metal material (as an example, aluminum alloy). In addition, the cylinder block 10 having the hollow portions 22 can be, for example, produced by casting as follows, instead of the three-dimensional molding machine. In more detail, the hollow portions 22 can be formed by, for example, inserting dissipating cores into a mold for forming the cylinder block 10. Additionally, if this alternative method is used, it is required to allow the cylinder block 10 to have channels for removing gases derived as a result of the dissipating cores being gasified when the cylinder block 10 is produced by casting, and the channels are required to be blocked after the casting process.

### Advantageous Effect of Cylinder Block with Hollow Portion

The supply of heat from combustion gas to a cylinder bore wall section is performed mainly with respect to a location of the cylinder bore wall section on the side closer to a cylinder head. Also, the longer the distance from the cylinder head is, the greater the influence of the heat from the combustion gas to the cylinder bore wall section becomes. Therefore, if no special consideration is given, the temperature of the cylinder bore wall section is basically higher on the side closer to the cylinder head than on the side away from the cylinder head. In more detail, the longer the distance from the cylinder head is, the lower the temperature of the cylinder bore wall section becomes. As a result of this, a temperature difference in the cylinder axial direction may be produced in the cylinder bore wall section.

In contrast to the above, the cylinder bore wall section 14 of the cylinder block 10 includes the hollow portions 22 on the side away from the cylinder head 18 in the cylinder axial direction as described so far. Each of the hollow portions 22 serves as a heat insulating layer, and hinders heat transfer in the cylinder bore wall section 14 from the side of the cylinder bore 12 toward the outer side in the cylinder radial direction. Therefore, with the configuration of the cylinder bore wall section 14 according to the present embodiment, as shown by the length of arrows in FIG. 2, the heat transfer (heat convection) from the side of each of the cylinder bores 12 toward the cylinder bore wall section 14 is facilitated at the location of the cylinder bore wall section 14 on the side where the hollow portion 22 is not provided (that is, at the location thereof on the side closer to the cylinder head 18). More specifically, the cylinder block 10 according to the present embodiment includes the water jacket 16, and thus, heat transfer toward the water jacket 16 is facilitated. On the other hand, at the location of the cylinder bore wall section 14 on the side where the hollow portion 22 is present (that is, at the location thereof on the side away from the cylinder head 18), the heat transfer toward the cylinder bore wall section 14 is reduced by the hollow portion 22.

On that basis, each of the hollow portions 22 is provided in the cylinder bore wall section 14 on the side away from the cylinder head 18 in the cylinder axial direction, and is formed such that the width of the hollow portion 22 in the cylinder radial direction is greater on the side away from the cylinder head 18 in the cylinder axial direction than on the side closer to the cylinder head 18. More specifically, each of the hollow portions 22 is formed such that the width of the hollow portion 22 in the cylinder radial direction is gradually greater as the hollow portion 22 is farther away from the cylinder head 18 in the cylinder axial direction. With respect to the transfer of heat in the cylinder bore wall section 14 toward the outer side in the cylinder radial direction, the greater the width of each of the hollow portions 22 in the cylinder radial direction is greater, the greater the heat insulating effect of each of the hollow portions 22 becomes. Therefore, according to the hollow portions 22, the heat insulating effect can be enhanced more effectively as the distance from the cylinder head 18 becomes longer. Consequently, as shown by the length of the arrows in FIG. 2, the heat transfer toward the cylinder bore wall section 14 can be reduced more effectively as the distance from the cylinder head 18 becomes longer.

From the above, according to the cylinder block 10 that includes the hollow portions 22 described above, the temperature difference in the cylinder bore wall section 14 (more specifically, the temperature difference at the location closer to the circumference surface of each of the cylinder bores 12) in the cylinder axial direction can be reduced effectively. With the reduction of this temperature difference, especially at the time of warm-up of the internal combustion engine, friction accompanying the slide of the pistons can be reduced and piston slap can be reduced.

Moreover, in order to ensure a high strength of the cylinder block 10, it is favorable that the location in which the hollow portion 22 is provided is reduced at a minimum necessary level. In this regard, in the present embodiment, the location in which each of the hollow portions 22 is provided in the cylinder circumferential direction is determined on the basis of the positional relationship between the hollow portion 22 and the water jacket 16. In more detail, in the view of the cylinder block 10 from the cylinder axial direction, each of the hollow portions 22 is formed only at the location of the cylinder bore wall section 14 on the inner side in the cylinder radial direction than the water jacket 16. Therefore, the heat transfer from the location where the heat transfer toward the outer side in the cylinder radial direction is required to be reduced in the cylinder bore wall section 14 (that is, from the location thereof on the side away from the cylinder head 18) toward the water jacket 16 can be reduced efficiently (that is, with the reduction of the location in which the hollow portion 22 is provided).

### Second Embodiment

Next, a second embodiment according to the present disclosure will be described with reference to FIG. 4. FIG. 4 is a schematic diagram for describing a configuration of hollow portions 32 included in a cylinder block 30 according to the second embodiment of the present disclosure. In addition, FIG. 4 shows a cross sectional shape of the cylinder block 30 at the similar position to that in FIG. 2.

The cylinder block 30 according to the present embodiment is configured in the same manner as the cylinder block 10 according to the first embodiment, except for the points that will be described below. To be more specific, each of the hollow portions 22 according to the first embodiment is formed such that the width of the hollow portion 22 in the cylinder radial direction becomes greater continuously as the distance from the cylinder head 18 in the cylinder axial direction becomes longer. In contrast to this, each of the hollow portions 32 according to the present embodiment is formed such that the width of the hollow portion 32 in the cylinder radial direction becomes greater gradually as the distance from the cylinder head 18 in the cylinder axial direction becomes longer. More specifically, as one example of this formation, each of the hollow portions 32 according to the present embodiment is formed in such a manner that, as shown in FIG. 4, the width of the hollow portion 32 in the cylinder radial direction becomes greater in a stepwise fashion as the distance from the cylinder head 18 in the cylinder axial direction becomes longer. According to the cylinder block 30 that includes the hollow portions 32 that are configured as just described, as with the cylinder block 10, the temperature difference in the cylinder bore wall section 14 (more specifically, the temperature difference at the location closer to the circumference surface of each of the cylinder bores 12) in the cylinder axial direction can be reduced.

### Third Embodiment

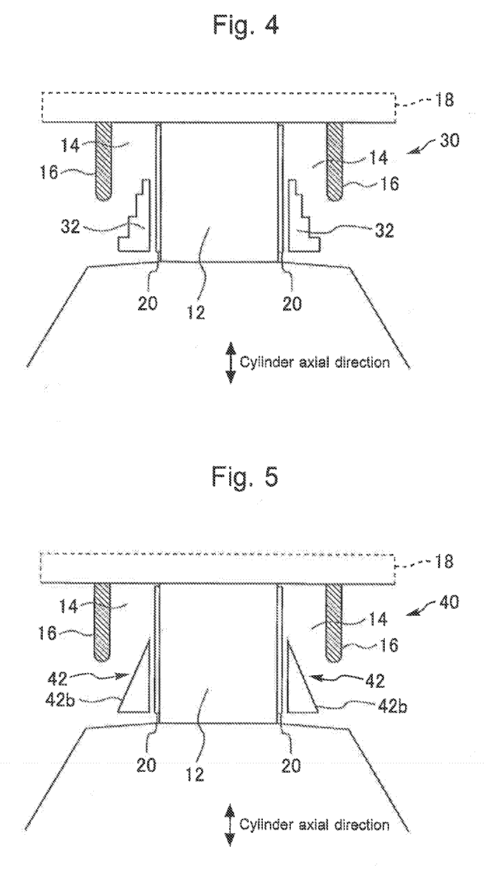

Next, a third embodiment according to the present disclosure will be described with reference to FIG. 5. FIG. 5 is a schematic diagram for describing a configuration of hollow portions 42 included in a cylinder block 40 according to the third embodiment of the present disclosure. In addition, FIG. 5 shows a cross sectional shape of the cylinder block 40 at the similar position to that in FIG. 2.

The difference between the cylinder block 40 according to the present embodiment and the cylinder block 10 according to the first embodiment is as follows. To be more specific, the outer circumferential surface 22b of each of the hollow portions 22 on the outer side in the cylinder radial direction according to the first embodiment is formed in the curved shape as shown by the cross-section that is perpendicular to the cylinder axis line L in FIG. 2. In contrast to this, an outer circumferential surface 42b of each of the hollow portions 42 on the outer side in the cylinder radial direction according to the present embodiment is formed by a line as shown by a cross-section that is perpendicular to the cylinder axial line L in FIG. 5. According to the cylinder block 40 that includes the hollow portions 42 that are configured as just described, as with the cylinder block 10 and cylinder block 30, the temperature difference in the cylinder bore wall section 14 (more specifically, the temperature difference at the location closer to the circumference surface of each of the cylinder bores 12) in the cylinder axial direction can be reduced.

### Other Embodiments

In the examples of the first to third embodiments described above, in the view of the cylinder block 10, 30 or 40 from the cylinder axial direction, with respect to the cylinder circumferential direction, each of the hollow portions 22, 32 or 42 is formed only at the location of the cylinder bore wall section 14 on the inner side in the cylinder radial direction than the water jacket 16. However, one or more hollow portions according to the present disclosure may be formed over the entire cylinder-circumferential direction, as needed.

Moreover, in the examples of the first to third embodiments described above, the width of each of the hollow portions 22, 32 or 42 in the cylinder radial direction is greatest at an end on the side away from the cylinder head 18 in the cylinder axial direction. However, the effect of the reduction of the temperature difference in the cylinder bore wall section in the cylinder axial direction can be achieved, as far as it meets the requirement that the hollow portion is formed such that the width of the hollow portion in the cylinder radial direction is greater at the location of the cylinder bore wall section 14 on the side away from the cylinder head in the cylinder axial direction than at the location of the cylinder bore wall section 14 on the side closer to the cylinder head. Therefore, in the hollow portion according to the present disclosure, the width of the hollow portion in the cylinder radial direction may not be necessarily greatest at an end on the side away from the cylinder head 18 in the cylinder axial direction, as far as it meets the requirement that the location of the cylinder bore wall section on the side closer to the cylinder head in the cylinder axial direction and the location of the cylinder bore wall section on the side away therefrom have the relationship described above. In addition, it can be said that the hollow portion contributes to the reduction of the temperature difference in the cylinder bore wall section in the cylinder axial direction even if the location of the cylinder bore wall section 14 on the side closer to the cylinder head in the cylinder axial direction and the location thereof on the side away therefrom are not formed integrally (that is, as one hollow space). Therefore, the hollow portion according to the present disclosure may be divided into arbitrary number of sub-portions in the cylinder axial direction.

Furthermore, in the examples of the first to third embodiments described above, the cylinder block (that is, a cylinder block for a water-cooled internal combustion engine) 10, 30 or 40 is used. However, one or more hollow portions according to the present disclosure may be applied to a cylinder block that does not include a water jacket (for example, a cylinder block for an air-cooled internal combustion engine). In addition, the hollow portion according to the present disclosure may be applied to a cylinder block that does not include a cylinder liner instead of the examples described above.

What is claimed is:

1. A cylinder block for an internal combustion engine, comprising a cylinder bore wall section configured to support a piston which reciprocates in a cylinder bore,
wherein the cylinder bore wall section includes a hollow portion at a location of the cylinder bore wall section on a side away from the cylinder head in a cylinder axial direction, and
wherein a width of the hollow portion in a cylinder radial direction is greater on the side away from the cylinder head in the cylinder axial direction than on a side closer to the cylinder head.

2. The cylinder block according to claim 1,
wherein the hollow portion is formed such that the width of the hollow portion in the cylinder radial direction becomes gradually greater as the hollow portion becomes farther away from the cylinder head in the cylinder axial direction.

3. The cylinder block according to claim 1,
wherein the cylinder block further comprises a water jacket formed so as to surround the cylinder bore wall section, and
wherein, in a view of the cylinder block from the cylinder axial direction, with respect to a cylinder circumferential direction, the hollow portion is formed only at a location of the cylinder bore wall section on an inner side in the cylinder radial direction than the water jacket.
